(19) United States
(12) Patent Application Publication
(10) Pub. No.: US 2022/0211117 A1
(43) Pub. Date: Jul. 7, 2022

(54) ELECTRONIC CIGARETTE PREHEATING METHOD AND PREHEATING SYSTEM

(71) Applicant: HUIZHOU HAPPY VAPING TECHNOLOGY LIMITED, Huizhou, Guangdong (CN)

(72) Inventors: Guangrong Lin, Shenzhen, Guangdong (CN); Xianbin Zheng, Shenzhen, Guangdong (CN); Xiyong Zhang, Shenzhen, Guangdong (CN)

(21) Appl. No.: 17/603,945

(22) PCT Filed: Jun. 2, 2020
(86) PCT No.: PCT/CN2020/094006

§ 371 Date: Oct. 15, 2021

(30) Foreign Application Priority Data
Jun. 26, 2019 (CN) 201910562931.3

(51) Int. Cl. A24F 40/65; A24F 40/57; A24F 40/60; A24F 40/53; G05D 23/19; H05B 1/02

(52) U.S. Cl. CPC A24F 40/65; A24F 40/57; H05B 1/0244; A24F 40/53; G05D 23/1917; A24F 40/60

(57) ABSTRACT

An electronic cigarette preheating method and preheating system are provided. The preheating method performs data interaction by communication connection established between an intelligent terminal and the electronic cigarette, allows for displaying and changing preheating parameters on a control software interface of the intelligent terminal, and sends the updated preheating parameters to the microcontroller MCU to replace previous preheating parameters preset in the microcontroller MCU. When the electronic cigarette is turned on, based on real-time temperature value detected by temperature sensor, determining whether preheating is required by means of the microcontroller MCU. If yes, based on preheating parameters and preset routine, controlling the heating device of the electronic cigarette by means of the microcontroller MCU to perform heating for the preset heating time or until the preset target temperature value is reached. Then, ending the preheating and entering the available stand-by state of the electronic cigarette.

### TECHNICAL FIELD

The disclosure relates to the field of electronic cigarette preheating technology, more particularly to an electronic cigarette preheating method and preheating system.

### BACKGROUND

The electronic cigarette usually heats and vaporizes liquid substances or paste-like substances, such as drugs and cigarette liquid, to produce aerosol or vapor for users to use. As people pay more attention to their health, they realize that tobacco may be harmful to health. Thus, the electronic cigarettes are widely used.

Existing electronic cigarette usually comprises cigarette liquid and a heating device for vaporizing the cigarette liquid. The cigarette liquid may be stored inside the liquid storage chamber. During vaporization, the cigarette liquid stored inside the liquid storage chamber may be permeated or fed to the heating device. Usually, when an electronic cigarette is turned on to operate, no preheating method or procedure is provided to warm up the electronic cigarette. In particular when the electronic cigarette is used in cold winter or at cold areas such as higher latitudes or higher elevations, the viscosity of the cigarette liquid or tobacco tar or liquid substances containing drugs of the electronic cigarette is increased and the fluidity thereof is reduced at low temperature. In such a case, it is not easy for the cigarette liquid or drugs to be permeated or fed to the heating device for vaporization, such that the vapor can hardly be produced when the electronic cigarette initially starts. To this end, it is desired to provide a preheating method which preheats the cigarette liquid or liquid substances containing drugs by means of the heating device during power-on self-test of the electronic cigarette, to facilitate production of the vapor.

### SUMMARY

### Technical Problem

An object of the disclosure is to overcome the above shortcomings and provide an electronic cigarette preheating method and preheating system.

### Technical Solutions

The disclosure provides a technical solution as follow. According to an electronic cigarette preheating method, setting preheating parameters and a preheating routine in a microcontroller MCU arranged in the electronic cigarette, performing data interaction by a communication connection established between an intelligent terminal and the electronic cigarette, and displaying and changing the preheating parameters on a control software interface of the intelligent terminal. The preheating parameters at least comprise preset temperature value, and preset heating time or preset target temperature value. The preheating routine comprises: when the electronic cigarette is turned on, sending preheating parameters changed on the control software interface to the microcontroller MCU to replace previous preset preheating parameters; detecting real-time temperature value by means of a temperature sensor arranged in the electronic cigarette; by means of the microcontroller MCU, comparing the real-time temperature value with the preset temperature value and determining whether preheating of the cigarette liquid stored inside the liquid storage chamber is required or not, if no, directly entering an available stand-by state of the electronic cigarette, if yes, controlling the heating device arranged in the electronic cigarette by means of the microcontroller MCU to perform heating for the preset heating time or until the preset target temperature value is reached, and then ending the preheating and entering the available stand-by state of the electronic cigarette.

Preferably, the control software interface may be configured with a preheating switch. When the preheating switch is turned off, sending an instruction of stopping preheating to the electronic cigarette by means of the intelligent terminal, and then stopping the preheating routine by means of the microcontroller MCU such that the heating device of the electronic cigarette is controlled to not preheat or stop preheating.

Preferably, when the microcontroller MCU determines the preheating is required, controlling the LED indicator light arranged on the electronic cigarette by means of the microcontroller MCU to emit light for warning. When the preheating is finished, controlling the vibrator arranged on the electronic cigarette by means of the microcontroller MCU to provide vibration for warning.

Preferably, the preset heating time may be a constant value or set as a function which is inversely proportional to the real-time temperature value. That is, the lower the real-time temperature value, the longer the period of the preset heating time.

Preferably, the preheating parameters may further comprise preset preheating power. The preset preheating power may be a constant value or set as a function which is inversely proportional to the real-time temperature value. That is, the lower the real-time temperature value, the greater the preset preheating power.

Preferably, the preheating parameters may further comprise preset stand-by time. After the electronic cigarette enters the available stand-by state, the electronic cigarette will automatically shut down if the electronic cigarette detects that the user does not take even a puff within the preset stand-by time.

Preferably, the microcontroller MCU may be configured to recurrently detect real-time temperature and determine whether the preheating is required again or not within the preset stand-by time, if yes, controlling the heating device of the electronic cigarette by means of the microcontroller MCU to perform heating again.

Preferably, the communication connection established between the intelligent terminal and the electronic cigarette may be wireless Bluetooth connection, or wireless WIFI connection, or wireless radio frequency (RFID) connection, or USB wired connection.

Preferably, the intelligent terminal may be a desktop computer, or a laptop, or a tablet computer, or a smartphone.

Preferably, the preset temperature value may be set to a range of −10° C.˜10° C., the preset heating time may be set to a range of 1˜5 seconds or the preset target temperature value may be set to a range of 10° C.˜80° C., and the stand-by time may be set to a range of 5-10 minutes.

Preferably, the preset preheating power may be a constant value set to a range of 2 W˜6 W.

Preferably, the method may comprise steps of:

(1) presetting the preheating parameters and the preheating routine on the microcontroller MCU;
(2) opening the intelligent terminal to change the preheating parameters or keep the preheating parameters unchanged on the control software interface;
(3) performing communication between the electronic cigarette and the intelligent terminal;
(4) turning on the electronic cigarette;
(5) by means of the microcontroller MCU arranged in the electronic cigarette, determining whether preheating parameters changed on the control software interface are received or not, if yes, go to next step; if no, go to step (7);
(6) updating the preheating parameters preset on the microcontroller MCU using the preheating parameters changed on the control software interface;
(7) detecting the real-time temperature value by means of the temperature sensor, and reading the real-time temperature value by means of the microcontroller MCU;
(8) determining whether the real-time temperature value is greater than the preset temperature value or not by means of the microcontroller MCU, if yes, go to step (10); if no, go to next step;
(9) controlling the heating device by means of the microcontroller MCU to perform heating for the preset heating time or until the preset target temperature value is reached;
(10) entering the available stand-by state of the electronic cigarette.

Preferably, the method may comprise steps of:

(1) presetting the preheating parameters and the preheating routine on the microcontroller MCU;
(2) opening the intelligent terminal to change the preheating parameters or keep the preheating parameters unchanged on the control software interface;
(3) performing communication between the electronic cigarette and the intelligent terminal;
(4) turning on the electronic cigarette;
(5) by means of the microcontroller MCU arranged in the electronic cigarette, determining whether preheating parameters changed on the control software interface are received or not, if yes, go to next step; if no, go to step (7);
(6) updating the preheating parameters preset on the microcontroller MCU using the preheating parameters changed on the control software interface;
(7) by means of the microcontroller MCU, determining whether the electronic cigarette receives an instruction of stopping preheating sent from the preheating switch of the control software interface or not, if yes, go to step (11); if no, go to next step;
(8) detecting the real-time temperature value by means of the temperature sensor, and reading the real-time temperature value by means of the microcontroller MCU;
(9) determining whether the real-time temperature value is greater than the preset temperature value or not by means of the microcontroller MCU, if yes, go to step (11); if no, go to next step;
(10) controlling the heating device by means of the microcontroller MCU to perform heating for the preset heating time or until the preset target temperature value is reached;
(11) entering the available stand-by state of the electronic cigarette.

Preferably, the method may comprise steps of:

(1) presetting the preheating parameters and the preheating routine on the microcontroller MCU;
(2) opening the intelligent terminal to change the preheating parameters or keep the preheating parameters unchanged on the control software interface;
(3) performing communication between the electronic cigarette and the intelligent terminal;
(4) turning on the electronic cigarette;
(5) by means of the microcontroller MCU arranged in the electronic cigarette, determining whether preheating parameters changed on the control software interface are received or not, if yes, go to next step; if no, go to step (7);
(6) updating the preheating parameters preset on the microcontroller MCU using the preheating parameters changed on the control software interface;
(7) by means of the microcontroller MCU, determining whether the electronic cigarette receives an instruction of stopping preheating sent from the preheating switch of the control software interface or not, if yes, go to step (12); if no, go to next step;
(8) detecting the real-time temperature value by means of the temperature sensor, and reading the real-time temperature value by means of the microcontroller MCU;
(9) determining whether the real-time temperature value is greater than the preset temperature value or not by means of the microcontroller MCU, if yes, go to step (12); if no, go to next step;
(10) emitting light for warning by means of the LED indicator light as the preheating is required;
(11) controlling the heating device by means of the microcontroller MCU to perform heating for the preset heating time or until the preset target temperature value is reached;
(12) providing vibration for warning by means of the vibrator;
(13) entering the available stand-by state of the electronic cigarette.

Preferably, the method may comprise steps of:

(1) presetting the preheating parameters and preheating routine on the microcontroller MCU;
(2) opening the intelligent terminal to change the preheating parameters or keep the preheating parameters unchanged on the control software interface;
(3) performing communication between the electronic cigarette and the intelligent terminal;
(4) turning on the electronic cigarette;
(5) by means of the microcontroller MCU arranged in the electronic cigarette, determining whether preheating parameters changed on the control software interface are received or not, if yes, go to next step; if no, go to step (7);
(6) updating the preheating parameters preset on the microcontroller MCU using the preheating parameters changed on the control software interface;
(7) detecting the real-time temperature value by means of the temperature sensor, and reading the real-time temperature value by means of the microcontroller MCU;
(8) determining whether the real-time temperature value is greater than the preset temperature value or not by means of the microcontroller MCU, if yes, go to step (10); if no, go to next step;
(9) controlling the heating device by means of the microcontroller MCU to perform heating for the preset heating time or until the preset target temperature value is reached;
(10) entering the available stand-by state of the electronic cigarette;
(11) going back to step (7) as the stand-by time does not pass;
(12) automatically shutting down the electronic cigarette as the stand-by time exceeds the preset stand-by time.

The disclosure provides another technical solution as follow. An electronic cigarette preheating system comprises an electronic cigarette and an intelligent terminal which establish a communication connection with each other to perform data interaction. The electronic cigarette comprises a liquid storage chamber, a heating device, a microcontroller MCU, and a temperature sensor. The microcontroller MCU is installed with the preheating parameters and the preheating routine. The intelligent terminal comprises the control software interface allowed for displaying and changing the preheating parameters. The preheating parameters at least include the preset temperature value, and the preset heating time or the preset target temperature value. The preheating routine is configured in such a manner that, when the electronic cigarette is turned on, the preheating parameters changed on the control software interface are sent to the microcontroller MCU, to replace previous preset preheating parameters. The temperature sensor is configured to detect the real-time temperature value. The microcontroller MCU is configured to compare the real-time temperature value with the preset temperature value and determine whether preheating of the cigarette liquid stored inside the liquid storage chamber is required or not. If no, the electronic cigarette directly enters an available stand-by state. If yes, the heating device arranged in the electronic cigarette is controlled by means of the microcontroller MCU to perform heating for the preset heating time or until the preset target temperature value is reached. Then, the preheating ends, and the electronic cigarette enters the available stand-by state.

Preferably, the preheating parameters may further include the preset stand-by time. The preheating routine may be configured in such a manner that, after the electronic cigarette enters the available stand-by state, the electronic cigarette will automatically shut down if the electronic cigarette detects that the user does not take even a puff within the preset stand-by time.

Preferably, the preheating parameters may further include the preset preheating power. The preset preheating power may be a constant value or set as a function which is inversely proportional to the real-time temperature value. That is, the lower the real-time temperature value, the greater the preset preheating power.

Preferably, the preset heating time may be a constant value or set as a function which is inversely proportional to the real-time temperature value. That is, the lower the real-time temperature value, the longer the period of the heating time.

Preferably, the control software interface may be configured with a preheating switch. When the preheating switch is turned off, the intelligent terminal sends an instruction of stopping preheating to the electronic cigarette, and then the microcontroller MCU stops the preheating routine such that the heating device of the electronic cigarette is controlled to not preheat or stop preheating.

Preferably, the electronic cigarette may be arranged with an LED indicator light and a vibrator. Herein, the LED indicator light may be controlled by means of the microcontroller MCU to emit light for warning when the preheating is required, and the vibrator may be controlled by means of the microcontroller MCU to provide vibration for warning when the preheating is finished.

Preferably, the intelligent terminal may be a desktop computer, or a laptop, or a tablet computer, or a smartphone, and the communication connection may be wireless Bluetooth connection, or wireless WIFI connection, or wireless radio frequency (RFID) connection, or USB wired connection.

Preferably, the preset temperature value may be set to a range of −10° C.˜10° C., the preset heating time may be set to a range of 1˜5 seconds, the preset target temperature value may be set to a range of 10° C.˜80° C., and the preset stand-by time may be set to a range of 5˜10 minutes.

Preferably, the preset preheating power may be a constant value set to a range of 2 W˜6 W.

### Advantages

The electronic cigarette preheating method and preheating system according to the disclosure achieve parameter setting and controlling by the communication connection established between the intelligent terminal and the electronic cigarette. The electronic cigarette is installed with automatic preheating control routine. After detecting real-time temperature, the electronic cigarette is capable of automatically determining whether preheating is required. The heating device of the electronic cigarette is used to perform heating and generate heat energy. As the heat energy is transferred to the liquid storage chamber of the electronic cigarette, the cigarette liquid or liquid substances containing drugs may be preheated.

### BRIEF DESCRIPTION OF THE DRAWINGS

FIG. 1 is a first flow chart of a control method according to the disclosure;

FIG. 2 is a second flow chart of a control method according to the disclosure;

FIG. 3 is a third flow chart of a control method according to the disclosure;

FIG. 4 is a fourth flow chart of a control method according to the disclosure;

FIG. 5 is a functional structural diagram according to the disclosure.

### DETAILED DESCRIPTION OF ILLUSTRATED EMBODIMENTS

In order to make purposes, technical solutions and advantages of the disclosure clearer, the disclosure will be further explained in detail with reference to drawings and embodiments described hereinafter. It should be understood that the specific embodiments described herein are only used to explain the present invention and are not intended to limit the present invention.

According to an electronic cigarette preheating method of the disclosure, setting preheating parameters and preheating routine in a microcontroller MCU arranged in the electronic cigarette, performing data interaction by a communication connection established between an intelligent terminal and the electronic cigarette, and displaying and changing the preheating parameters on a control software interface of the intelligent terminal. The preheating parameters at least include preset temperature value, and preset heating time or preset target temperature value. The preheating routine comprises: when turning on the electronic cigarette, sending preheating parameters changed on the control software interface to the microcontroller MCU to replace previous preset preheating parameters; detecting real-time temperature value by means of a temperature sensor arranged in the electronic cigarette; by means of the microcontroller MCU, comparing the real-time temperature value with the preset temperature value, and determining whether preheating of the cigarette liquid stored inside the liquid storage chamber is required or not, if no, directly entering an available stand-by state of the electronic cigarette, if yes, controlling the heating device arranged in the electronic cigarette by means of the microcontroller MCU to perform preheating for the preset heating time or until the preset target temperature value is reached, and then ending the preheating and entering the available stand-by state of the electronic cigarette.

Among the preheating parameters in the embodiment, either the preset heating time or the preset target temperature value, but not both at the same time, may be set. The cigarette liquid stored inside the liquid storage chamber according to the disclosure may be flowable cigarette liquid, or tobacco tar having poor fluidity or waxy solid formed by solidification of tobacco tar, or liquid substances containing drugs, or waxy solid formed by solidification of drug liquid, etc.

### First Embodiment

In the electronic cigarette preheating method according to the embodiment, the communication connection established between the intelligent terminal and the electronic cigarette may be USB wired connection. The intelligent terminal may be a laptop installed with control software and display interface. After the control software is opened, new preheating parameters may be set on the display interface. The preheating parameters may include the preset temperature value and the preset target temperature value. In particular, the preset temperature value may be set to a range of −10° C.˜10° C., and the preset target temperature value may be set to a range of 10° C.˜80° C.

In another embodiment, the communication connection established between the intelligent terminal and the electronic cigarette may be wireless signal connection, e.g., wireless Bluetooth connection, or wireless WIFI connection, or wireless radio frequency (RFID) connection.

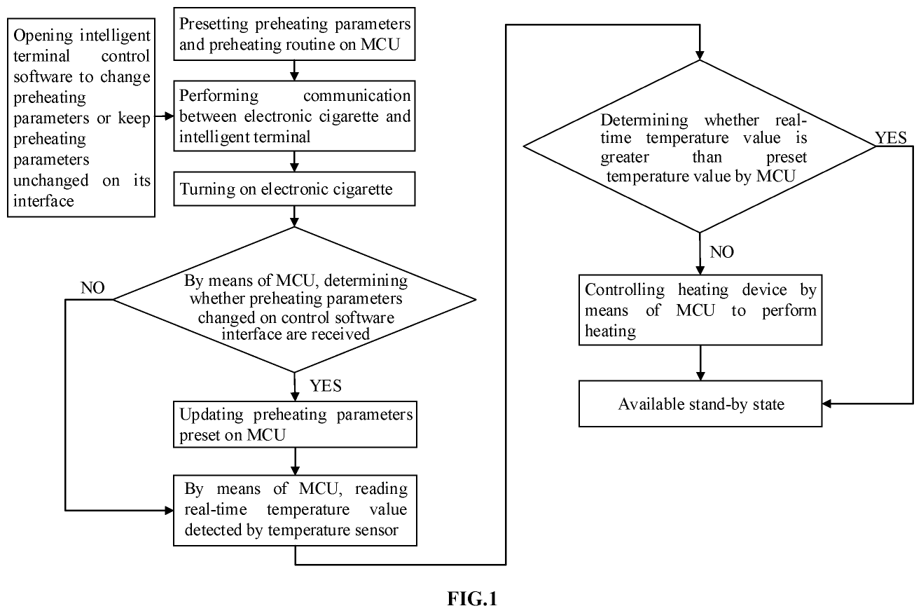

Referring to FIG. 1, the electronic cigarette preheating method according to the first embodiment comprises steps as follows.

(1) Presetting the preheating parameters and the preheating routine on the microcontroller MCU;
(2) Opening the intelligent terminal to change the preheating parameters or keep the preheating parameters unchanged on the control software interface;
(3) Performing communication between the electronic cigarette and the intelligent terminal;
(4) Turning on the electronic cigarette;
(5) By means of the microcontroller MCU arranged in the electronic cigarette, determining whether the preheating parameters changed on the control software interface are received or not, if yes, go to next step; if no, go to step (7);
(6) Updating the preheating parameters preset on the microcontroller MCU using the preheating parameters changed on the control software interface;
(7) Detecting the real-time temperature value by means of the temperature sensor, and reading the real-time temperature value by means of the microcontroller MCU;
(8) Determining whether the real-time temperature value is greater than the preset temperature value or not by means of the microcontroller MCU, if yes, go to step (10); if no, go to next step;
(9) Controlling the heating device by means of the microcontroller MCU to perform heating until the preset target temperature value is reached;
(10) Entering the available stand-by state of the electronic cigarette.

### Second Embodiment

In the electronic cigarette preheating method according to the embodiment, the communication connection established between the intelligent terminal and the electronic cigarette may be wireless Bluetooth connection. The intelligent terminal may be a laptop installed with control software and display interface. After the control software is opened, new preheating parameters may be set on the display interface. The preheating parameters may include the preset temperature value and the preset heating time. In particular, the preset temperature value may be set to a range of −10° C.˜10° C., the preset heating time may be set to a range of 1˜5 seconds. In the embodiment, the control software interface installed on the laptop is further arranged with a preheating switch. The default setting of the preheating switch may be ON, i.e., according to the default setting, the preheating routine is required. When the preheating switch is turned off, sending an instruction of stopping preheating to the electronic cigarette by means of the laptop, and then stopping the preheating routine by means of the microcontroller MCU of the electronic cigarette such that the heating device of the electronic cigarette is controlled to not preheat or stop preheating. The preheating switch may be configured to have a default state in which the preheating switch is restored back to ON each time when the electronic cigarette is restarted after being shut off.

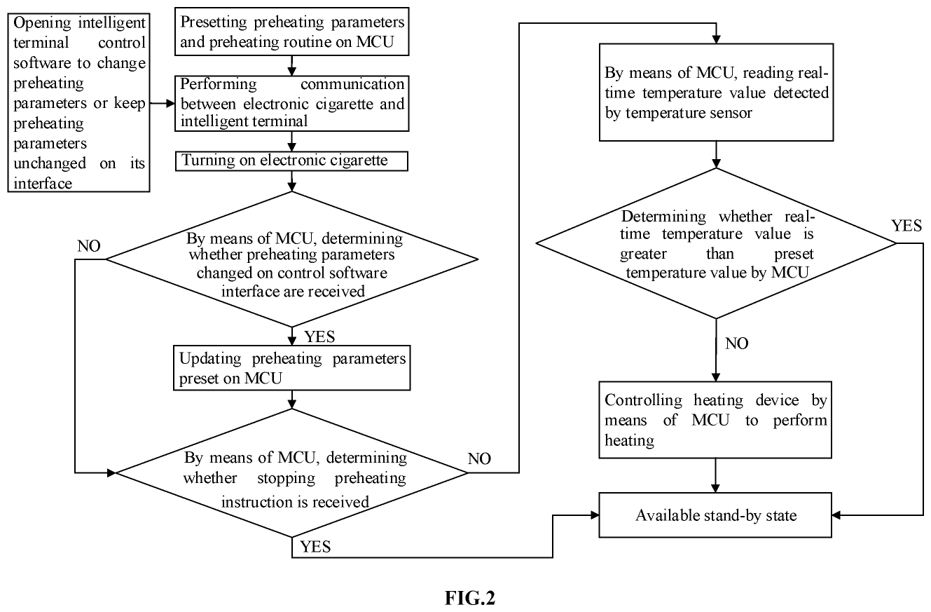

Referring to FIG. 2, the electronic cigarette preheating method according to the second embodiment comprises steps as follows.

(1) Presetting the preheating parameters and the preheating routine on the microcontroller MCU;
(2) Opening the intelligent terminal to change the preheating parameters or keep the preheating parameters unchanged on the control software interface;
(3) Performing communication between the electronic cigarette and the intelligent terminal;
(4) Turning on the electronic cigarette;
(5) By means of the microcontroller MCU arranged in the electronic cigarette, determining whether the preheating parameters changed on the control software interface are received or not, if yes, go to next step; if no, go to step (7);
(6) Updating the preheating parameters preset on the microcontroller MCU using the preheating parameters changed on the control software interface;
(7) By means of the microcontroller MCU, determining whether the electronic cigarette receives an instruction of stopping preheating sent from the preheating switch of the control software interface or not, if yes, go to step (11); if no, go to next step;
(8) Detecting the real-time temperature value by means of the temperature sensor, and reading the real-time temperature value by means of the microcontroller MCU;
(9) Determining whether the real-time temperature value is greater than the preset temperature value or not by means of the microcontroller MCU, if yes, go to step (11); if no, go to next step;
(10) Controlling the heating device by means of the microcontroller MCU to perform heating for the preset heating time of the preheating parameters;
(11) Entering the available stand-by state of the electronic cigarette.

### Third Embodiment

In the electronic cigarette preheating method according to the embodiment, the communication connection established between the intelligent terminal and the electronic cigarette may be wireless Bluetooth connection. The intelligent terminal may be a smartphone installed with APP control software and APP display interface. After the APP control software is opened, new preheating parameters may be set on the APP display interface. The preheating parameters may include the preset temperature value and the preset heating time.

In particular, the preset temperature value according to the embodiment may be set to a range of −10° C.˜10° C., the preset heating time may be set to a range of 1˜5 seconds.

In the embodiment, the APP control software interface installed on the smartphone is further arranged with a preheating switch. The default setting of the preheating switch may be ON, i.e., according to the default setting, the preheating routine is required. When the user clicks and turns off the preheating switch, sending an instruction of stopping preheating to the electronic cigarette through Bluetooth communication by means of the smartphone APP, and then stopping the preheating routine by means of the microcontroller MCU of the electronic cigarette such that the heating device of the electronic cigarette is controlled to not preheat or stop preheating. The preheating switch may be configured to have a default state in which the preheating switch is restored back to ON each time when the electronic cigarette is restarted after being shut off.

When it is necessary to perform preheating, in the meantime controlling the LED indicator light arranged on the electronic cigarette by means of the microcontroller MCU, to emit light for warning. The LED indicator light may emit light to warn the user that the electronic cigarette is entering the preheating routine. During such period, the electronic cigarette cannot produce vapor normally. When the preheating is finished, controlling the vibrator arranged on the electronic cigarette by means of the microcontroller MCU, to provide vibration for warning.

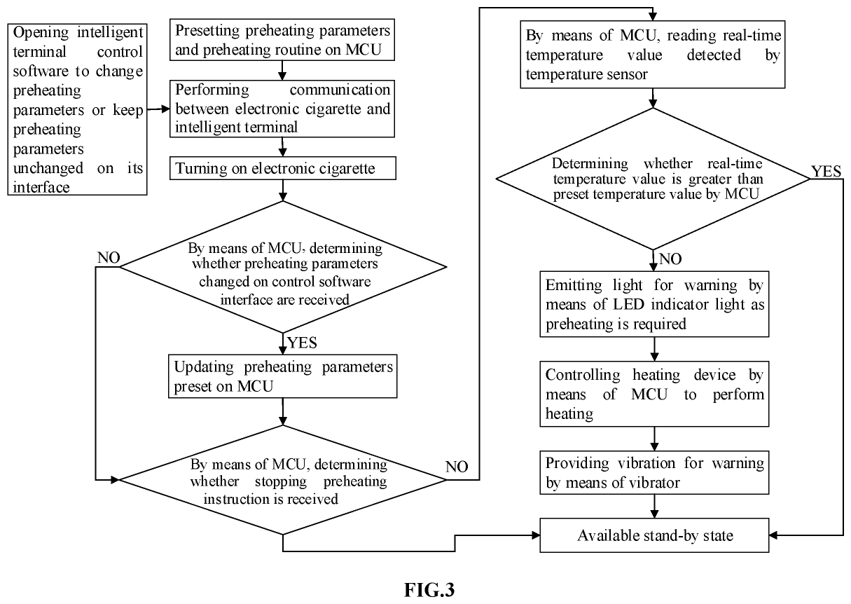

Referring to FIG. 3, the electronic cigarette preheating method according to the third embodiment comprises steps as follows.

(1) Presetting the preheating parameters and the preheating routine on the microcontroller MCU;
(2) Opening the intelligent terminal to change the preheating parameters or keep the preheating parameters unchanged on the control software interface;
(3) Performing communication between the electronic cigarette and the intelligent terminal;
(4) Turning on the electronic cigarette;
(5) By means of the microcontroller MCU arranged in the electronic cigarette, determining whether the preheating parameters changed on the control software interface are received or not, if yes, go to next step; if no, go to step (7);
(6) Updating the preheating parameters preset on the microcontroller MCU using the preheating parameters changed on the control software interface;
(7) By means of the microcontroller MCU, determining whether the electronic cigarette receives an instruction of stopping preheating sent from the preheating switch of the control software interface or not, if yes, go to step (12); if no, go to next step;
(8) Detecting the real-time temperature value by means of the temperature sensor, and reading the real-time temperature value by means of the microcontroller MCU;
(9) Determining whether the real-time temperature value is greater than the preset temperature value or not by means of the microcontroller MCU, if yes, go to step (12); if no, go to next step;
(10) Emitting light for warning by means of the LED indicator light as the preheating is required;
(11) Controlling the heating device by means of the microcontroller MCU to perform heating for the preset heating time;
(12) Providing vibration for warning by means of the vibrator;
(13) Entering the available stand-by state of the electronic cigarette.

### Fourth Embodiment

In the electronic cigarette preheating method according to the embodiment, the communication connection established between the intelligent terminal and the electronic cigarette may be wireless Bluetooth connection. The intelligent terminal may be a smartphone installed with APP control software and APP display interface. After the APP control software is opened, new preheating parameters may be set on the APP display interface. The preheating parameters may include the preset temperature value, the preset heating time, and the preset stand-by time. As the preheating parameters include the preset stand-by time, after electronic cigarette enters the available stand-by state, the electronic cigarette will automatically shut down if the electronic cigarette detects that the user does not take even a puff within the preset stand-by time. In addition, according to the embodiment, the microcontroller MCU is configured to recurrently detect real-time temperature and determine whether the preheating is required again or not within the preset stand-by time, if yes, controlling the heating device of the electronic cigarette by means of the microcontroller MCU to perform heating again.

In the embodiment, the preset heating time may be set as a function which is inversely proportional to the real-time temperature value. That is, the lower the detected real-time temperature value, the longer the period of heating time. In this way, more energy may be provided, and improved preheating effect may be achieved.

In another embodiment, the preheating parameters further include the preset preheating power. The preset preheating power may be a constant value for example set to a range of 2 W˜6 W. The preset preheating power may be set as a function which is inversely proportional to the real-time temperature value. That is, the lower the real-time temperature value, the greater the preset preheating power. In this way, more energy may be provided, and improved preheating effect may be achieved. In particular, the preset temperature value according to the embodiment may be set to a range of −10° C.˜10° C., the stand-by time may be set to a range of 5˜10 minutes. The preset heating time may be set as a function which is inversely proportional to the real-time temperature value.

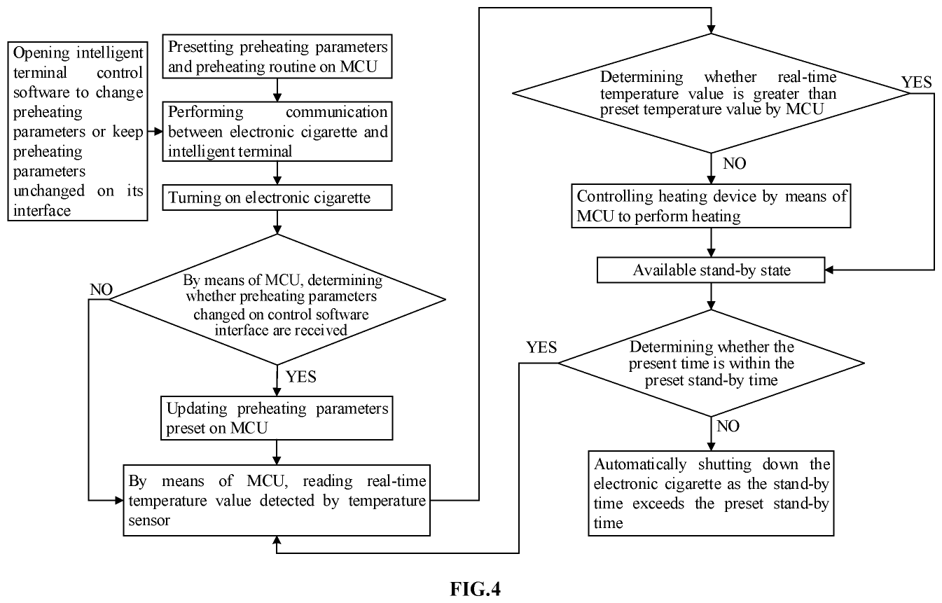

Referring to FIG. 4, the electronic cigarette preheating method according to the fourth embodiment comprises steps as follows.

(1) Presetting the preheating parameters and the preheating routine on the microcontroller MCU;
(2) Opening the intelligent terminal to change the preheating parameters or keep the preheating parameters unchanged on the control software interface;
(3) Performing communication between the electronic cigarette and the intelligent terminal;
(4) Turning on the electronic cigarette;
(5) By means of the microcontroller MCU arranged in the electronic cigarette, determining whether the preheating parameters changed on the control software interface are received or not, if yes, go to next step; if no, go to step (7);
(6) Updating the preheating parameters preset on the microcontroller MCU using the preheating parameters changed on the control software interface;
(7) Detecting the real-time temperature value by means of the temperature sensor, and reading the real-time temperature value by means of the microcontroller MCU;
(8) Determining whether the real-time temperature value is greater than the preset temperature value or not by means of the microcontroller MCU, if yes, go to step (10); if no, go to next step;
(9) Controlling the heating device by means of the microcontroller MCU to perform heating for the preset heating time;
(10) Entering the available stand-by state of the electronic cigarette;
(11) Going back to step (7) as the stand-by time does not pass;
(12) Automatically shutting down the electronic cigarette as the stand-by time exceeds the preset stand-by time.

### Embodiment of Another Technical Solution According to the Disclosure

An electronic cigarette preheating system comprises an electronic cigarette and an intelligent terminal which establish a communication connection with each other to perform data interaction. The electronic cigarette comprises a liquid storage chamber, a heating device, a microcontroller MCU, and a temperature sensor. The microcontroller MCU is installed with the preheating parameters and the preheating routine. The intelligent terminal comprises the control software interface allowed for displaying and changing the preheating parameters. The preheating parameters at least include the preset temperature value, and the preset heating time or the preset target temperature value. The preheating routine is configured in such a manner that, when the electronic cigarette is turned on, the preheating parameters changed on the control software interface are sent to the microcontroller MCU, to replace previous preset preheating parameters. The temperature sensor is configured to detect the real-time temperature value. The microcontroller MCU is configured to compare the real-time temperature value with the preset temperature value and determine whether preheating of the cigarette liquid stored inside the liquid storage chamber is required or not. If no, the electronic cigarette directly enters an available stand-by state. If yes, the heating device arranged in the electronic cigarette is controlled by means of the microcontroller MCU to perform heating for the preset heating time or until the preset target temperature value is reached. Then, the preheating ends, and the electronic cigarette enters the available stand-by state. Among the preheating parameters, either the preset heating time or the preset target temperature value, but not both at the same time, may be set.

The heating device is arranged inside the electronic cigarette, and the heating coil is arranged inside the heating device. When the heating coil is energized, it generates heat and heats the cigarette liquid of the electronic cigarette such that the cigarette liquid may be vaporized at high temperature to produce electronic cigarette vapor. The temperature sensor is arranged in the electronic cigarette. Since the preheating aims to the cigarette liquid stored inside the liquid storage chamber and the detection of real time temperature mainly refers to the determination of the temperature of the cigarette liquid, it is advantageous that the temperature sensor is arranged as close as possible to the liquid storage chamber of the electronic cigarette.

The preheating parameters may further include the preset stand-by time. The preheating routine is configured in such a manner that, after the electronic cigarette enters the available stand-by state, the electronic cigarette will automatically shut down if the electronic cigarette detects that the user does not take even a puff within the preset stand-by time.

The preheating parameters may further include the preset preheating power. The intelligent terminal is configured in such a manner that, the preset preheating power may be a constant value or set as a function which is inversely proportional to the real-time temperature value. That is, the lower the real-time temperature value, the greater the preset preheating power. The preset heating time may be set as a function which is inversely proportional to the real-time temperature value. That is, the lower the real-time temperature value, the longer the period of the heating time.

The intelligent terminal according to the disclosure may be a desktop computer, or a laptop, or a tablet computer, or a smartphone. The communication connection may be wireless Bluetooth connection, or wireless WIFI connection, or wireless radio frequency (RFID) connection, or USB wired connection.

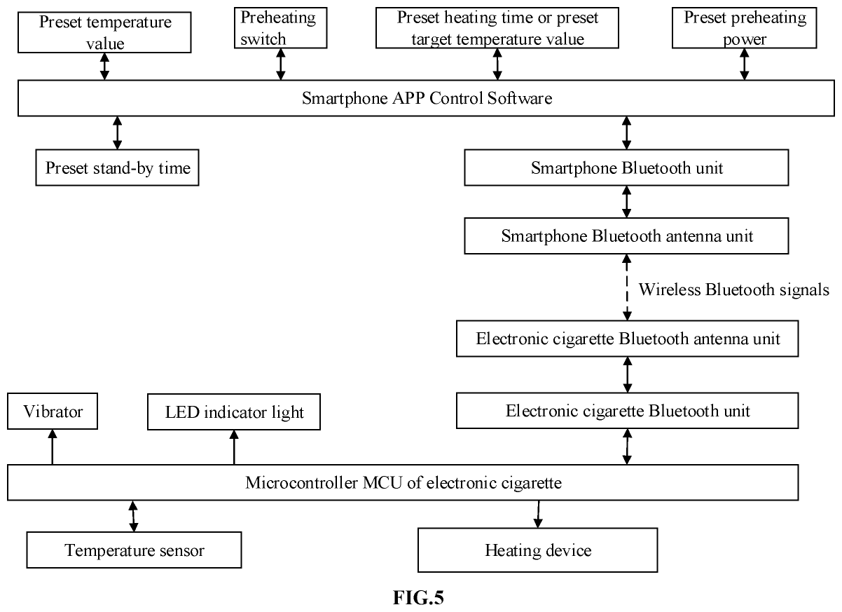

Referring to FIG. 5, the intelligent terminal according to the embodiment may be a smartphone installed with APP control software and APP display interface. After the APP control software is opened, new preheating parameters may be set on the APP display interface. The preheating parameters may include the preset temperature value, the preset heating time or the preset target temperature value, the stand-by time, and the preset preheating power. The communication connection may be wireless Bluetooth connection, and the Bluetooth connection device may comprise smartphone Bluetooth unit, smartphone Bluetooth antenna unit, electronic cigarette Bluetooth unit, and electronic cigarette Bluetooth antenna unit. Interactive data of the communication between the smartphone and the electronic cigarette may be transmitted by the smartphone Bluetooth antenna unit and the electronic cigarette antenna unit which send wireless Bluetooth signals to each other.

The control software interface of the smartphone APP is further arranged with the preheating switch. When the preheating switch is turned off, the smartphone sends an instruction of stopping preheating to the electronic cigarette, and then the microcontroller MCU stops the preheating routine such that the heating device of the electronic cigarette is controlled to not preheat or stop preheating.

The electronic cigarette may be further arranged with an LED indicator light and a vibrator. When it is necessary to perform preheating, the microcontroller MCU controls the LED indicator light to emit light for warning. When the preheating is finished, the microcontroller MCU controls the vibrator to provide vibration for warning.

In the electronic cigarette preheating system according to the disclosure the preset temperature value may be set to a range of −10° C.˜10° C., the preset heating time may be set to a range of 1˜5 seconds, the preset target temperature value may be set to a range of 10° C.˜80° C., and the preset preheating power may be a constant value set to a range of 2 W˜6 W.

### INDUSTRIAL APPLICABILITY

All the above are merely preferred embodiments of the disclosure. The present invention is intended to cover all modifications and equivalent arrangements those skilled in the art can make according to the technical essence of the present invention.

1. An electronic cigarette preheating method, comprising setting preheating parameters and preheating routine in a microcontroller MCU arranged in the electronic cigarette, performing data interaction by a communication connection established between an intelligent terminal and the electronic cigarette, and displaying and changing the preheating parameters on a control software interface of the intelligent terminal, wherein the preheating parameters at least comprise preset temperature value, and preset heating time or preset target temperature value, wherein the preheating routine comprises: when the electronic cigarette is turned on, sending preheating parameters changed on the control software interface to the microcontroller MCU to replace previous preset preheating parameters; detecting real-time temperature value by means of a temperature sensor arranged in the electronic cigarette; by means of the microcontroller MCU, comparing the real-time temperature value with the preset temperature value and determining whether preheating of the cigarette liquid stored inside the liquid storage chamber is required or not, if no, directly entering an available stand-by state of the electronic cigarette, if yes, controlling the heating device arranged in the electronic cigarette by means of the microcontroller MCU to perform heating for the preset heating time or until the preset target temperature value is reached, and then ending the preheating and entering the available stand-by state of the electronic cigarette.

2. The electronic cigarette preheating method according to claim 1, wherein the control software interface is configured with a preheating switch, and when the preheating switch is turned off, sending an instruction of stopping preheating to the electronic cigarette by means of the intelligent terminal, and then stopping the preheating routine by means of the microcontroller MCU such that the heating device of the electronic cigarette is controlled to not preheat or stop preheating.

3. The electronic cigarette preheating method according to claim 1, wherein when the microcontroller MCU determines the preheating is required, controlling an LED indicator light arranged on the electronic cigarette by means of the microcontroller MCU to emit light for warning, and when the preheating is finished, controlling a vibrator arranged on the electronic cigarette by means of the microcontroller MCU to provide vibration for warning.

4. The electronic cigarette preheating method according to claim 1, wherein the preset heating time is a constant value or set as a function which is inversely proportional to the real-time temperature value, that is, the lower the real-time temperature value, the longer the period of the preset heating time.

5. The electronic cigarette preheating method according to claim 1, wherein the preheating parameters further comprises preset preheating power, and the preset preheating power is a constant value or set as a function which is inversely proportional to the real-time temperature value, that is, the lower the real-time temperature value, the greater the preset preheating power.

6. The electronic cigarette preheating method according to claim 1, wherein the preheating parameters further comprises preset stand-by time, and after the electronic cigarette enters the available stand-by state, the electronic cigarette automatically shuts down if it detects that the user does not take even a puff within the preset stand-by time.

7. The electronic cigarette preheating method according to claim 6, wherein the microcontroller MCU is configured to recurrently detect real-time temperature and determine whether the preheating is required again or not within the preset stand-by time, if yes, controlling the heating device of the electronic cigarette by means of the microcontroller MCU to perform heating again.

8-11. (canceled)

12. The electronic cigarette preheating method according to claim 1, wherein the method comprises steps of:
(1) presetting the preheating parameters and the preheating routine on the microcontroller MCU;
(2) opening the intelligent terminal to change the preheating parameters or keep the preheating parameters unchanged on the control software interface;
(3) performing communication between the electronic cigarette and the intelligent terminal;
(4) turning on the electronic cigarette;
(5) by means of the microcontroller MCU arranged in the electronic cigarette, determining whether preheating parameters changed on the control software interface are received or not, if yes, go to next step; if no, go to step (7);
(6) updating the preheating parameters preset on the microcontroller MCU using the preheating parameters changed on the control software interface;
(7) detecting the real-time temperature value by means of the temperature sensor, and reading the real-time temperature value by means of the microcontroller MCU;
(8) determining whether the real-time temperature value is greater than the preset temperature value or not by means of the microcontroller MCU, if yes, go to step (10); if no, go to next step;
(9) controlling the heating device by means of the microcontroller MCU to perform heating for the preset heating time or until the preset target temperature value is reached;
(10) entering the available stand-by state of the electronic cigarette.

13. The electronic cigarette preheating method according to claim 2, wherein the method comprises steps of:
(1) presetting the preheating parameters and the preheating routine on the microcontroller MCU;
(2) opening the intelligent terminal to change the preheating parameters or keep the preheating parameters unchanged on the control software interface;
(3) performing communication between the electronic cigarette and the intelligent terminal;
(4) turning on the electronic cigarette;
(5) by means of the microcontroller MCU arranged in the electronic cigarette, determining whether preheating parameters changed on the control software interface are received or not, if yes, go to next step; if no, go to step (7);
(6) updating the preheating parameters preset on the microcontroller MCU using the preheating parameters changed on the control software interface;
(7) by means of the microcontroller MCU, determining whether the electronic cigarette receives an instruction of stopping preheating sent from the preheating switch of the control software interface or not, if yes, go to step (11); if no, go to next step;
(8) detecting the real-time temperature value by means of the temperature sensor, and reading the real-time temperature value by means of the microcontroller MCU;
(9) determining whether the real-time temperature value is greater than the preset temperature value or not by means of the microcontroller MCU, if yes, go to step (11); if no, go to next step;
(10) controlling the heating device by means of the microcontroller MCU to perform heating for the preset heating time or until the preset target temperature value is reached;
(11) entering the available stand-by state of the electronic cigarette.

14. The electronic cigarette preheating method according to claim 3, wherein the method comprises steps of:
(1) presetting the preheating parameters and the preheating routine on the microcontroller MCU;
(2) opening the intelligent terminal to change the preheating parameters or keep the preheating parameters unchanged on the control software interface;
(3) performing communication between the electronic cigarette and the intelligent terminal;
(4) turning on the electronic cigarette;
(5) by means of the microcontroller MCU arranged in the electronic cigarette, determining whether preheating parameters changed on the control software interface are received or not, if yes, go to next step; if no, go to step (7);
(6) updating the preheating parameters preset on the microcontroller MCU using the preheating parameters changed on the control software interface;
(7) by means of the microcontroller MCU, determining whether the electronic cigarette receives an instruction of stopping preheating sent from the preheating switch of the control software interface or not, if yes, go to step (12); if no, go to next step;
(8) detecting the real-time temperature value by means of the temperature sensor, and reading the real-time temperature value by means of the microcontroller MCU;
(9) determining whether the real-time temperature value is greater than the preset temperature value or not by means of the microcontroller MCU, if yes, go to step (12); if no, go to next step;
(10) emitting light for warning by means of the LED indicator light as the preheating is required;
(11) controlling the heating device by means of the microcontroller MCU to perform heating for the preset heating time or until the preset target temperature value is reached;
(12) providing vibration for warning by means of the vibrator;
(13) entering the available stand-by state of the electronic cigarette.

15. The electronic cigarette preheating method according to claim 7, wherein the method comprises steps of:
(1) presetting the preheating parameters and preheating routine on the microcontroller MCU;
(2) opening the intelligent terminal to change the preheating parameters or keep the preheating parameters unchanged on the control software interface;
(3) performing communication between the electronic cigarette and the intelligent terminal;
(4) turning on the electronic cigarette;
(5) by means of the microcontroller MCU arranged in the electronic cigarette, determining whether preheating parameters changed on the control software interface are received or not, if yes, go to next step; if no, go to step (7);
(6) updating the preheating parameters preset on the microcontroller MCU using the preheating parameters changed on the control software interface;
(7) detecting the real-time temperature value by means of the temperature sensor, and reading the real-time temperature value by means of the microcontroller MCU;
(8) determining whether the real-time temperature value is greater than the preset temperature value or not by means of the microcontroller MCU, if yes, go to step (10); if no, go to next step;
(9) controlling the heating device by means of the microcontroller MCU to perform heating for the preset heating time or until the preset target temperature value is reached;
(10) entering the available stand-by state of the electronic cigarette;
(11) going back to step (7) as the stand-by time does not pass;
(12) automatically shutting down the electronic cigarette as the stand-by time exceeds the preset stand-by time.

16. An electronic cigarette preheating system, comprising an electronic cigarette and an intelligent terminal which establish a communication connection with each other to perform data interaction, wherein the electronic cigarette comprises a liquid storage chamber, a heating device, a microcontroller MCU, and a temperature sensor, wherein the microcontroller MCU is installed with preheating parameters and preheating routine, wherein the intelligent terminal comprises control software interface allowed for displaying and changing the preheating parameters, and the preheating parameters at least comprise preset temperature value, and preset heating time or preset target temperature value, wherein the preheating routine is configured in such a manner that, when the electronic cigarette is turned on, the preheating parameters changed on the control software interface are sent to the microcontroller MCU, to replace previous preset preheating parameters, the temperature sensor is configured to detect the real-time temperature value, the microcontroller MCU is configured to compare the real-time temperature value with the preset temperature value and determine whether preheating of cigarette liquid stored inside the liquid storage chamber is required or not, if no, the electronic cigarette directly enters an available stand-by state, if yes, the heating device arranged in the electronic cigarette is controlled by means of the microcontroller MCU to perform heating for the preset heating time or until the preset target temperature value is reached, and then the preheating ends and the electronic cigarette enters the available stand-by state.

17. The electronic cigarette preheating system according to claim 16, wherein the preheating parameters further comprise preset stand-by time, the preheating routine is configured in such a manner that, after the electronic cigarette enters the available stand-by state, the electronic cigarette automatically shuts down if it detects that the user does not take even a puff within the preset stand-by time.

18. The electronic cigarette preheating system according to claim 16, wherein the preheating parameters further comprise preset preheating power, the preset preheating power is a constant value or set as a function which is inversely proportional to the real-time temperature value, that is, the lower the real-time temperature value, the greater the preset preheating power.

19. The electronic cigarette preheating system according to claim 16, wherein the preset heating time is a constant value or set as a function which is inversely proportional to the real-time temperature value, that is, the lower the real-time temperature value, the longer the period of the heating time.

20. The electronic cigarette preheating system according to claim 16, wherein the control software interface is configured with a preheating switch, and when the preheating switch is turned off, the intelligent terminal sends an instruction of stopping preheating to the electronic cigarette, and then the microcontroller MCU stops the preheating routine such that the heating device of the electronic cigarette is controlled to not preheat or stop preheating.

21. The electronic cigarette preheating system according to claim 16, wherein the electronic cigarette is arranged with an LED indicator light and a vibrator, wherein the LED indicator light is controlled by means of the microcontroller MCU to emit light for warning when the preheating is required, and the vibrator is controlled by means of the microcontroller MCU to provide vibration for warning when the preheating is finished.

22. The electronic cigarette preheating system according to claim 16, wherein the intelligent terminal is a desktop computer, or a laptop, or a tablet computer, or a smartphone, and the communication connection is wireless Bluetooth connection, or wireless WIFI connection, or wireless radio frequency RFID connection, or USB wired connection.

23. The electronic cigarette preheating system according to claim 17, wherein the preset temperature value is set to a range of −10° C.˜10° C., the preset heating time is set to a range of 1˜5 seconds, the preset target temperature value is set to a range of 10° C.˜80° C., and the preset stand-by time is set to a range of 5˜10 minutes.

24. The electronic cigarette preheating system according to claim 18, wherein the preset preheating power is a constant value set to a range of 2 W˜6 W.
